(19) United States
(12) Patent Application Publication
(10) Pub. No.: US 2005/0236260 A1
(43) Pub. Date: Oct. 27, 2005

(54) Micro-electromechanical switch array

(75) Inventors: Nicholas F. Pasch, Pacifica, CA (US); Glenn C. Sanders, Mountain View, CA (US); Hajime Seki, San Jose, CA (US)

Correspondence Address: CARPENTER & KULAS, LLP, 1900 EMBARCADERO ROAD, SUITE 109, PALO ALTO, CA, 94303, US

(73) Assignee: Rolltronics Corporation, Menlo Park, CA (US)

(21) Appl. No.: 11/046,325

(22) Filed: Jan. 27, 2005

Related U.S. Application Data
(60) Provisional application No. 60/540,443, filed on Jan. 29, 2004.
(60) Provisional application No. 60/543,170, filed on Feb. 10, 2004.

(51) Int. Cl. H01H 57/00

(52) U.S. Cl. 200/181

(57) ABSTRACT

Micro-electromechanical devices having an improved flexible layer enable the use of material having a wider range of elastic modulus. The MEM devices include a substantially non-pliable layer and a substantially flexible layer both of which include electrodes that when energized will create electrostatic forces that attracts the flexible layer to the non-pliable layer. The flexible layer has perforations or apertures cut into the flexible layer of a MEMs device to alter operational properties such as electrostatic sensitivity, resonance frequency, rate of change of sensitivity above the resonance frequency, oscillating mass, panel stiffness and others parameters.

### CROSS-REFERENCES TO RELATED APPLICATIONS

This application is related to commonly assigned provisional patent application entitled “IMPROVEMENTS IN ELECTROMECHANICAL SWITCH ARRAY TO INCREASE RELIABILITY” by Nicholas F. Pasch et al, application No. 60/540,443, filed Jan. 29, 2004 and “SLOTS 1” by Nicholas F. Pasch et al., application No. 60/543,170, filed Feb. 10, 2004, the entire disclosures of which are herein incorporated by reference for all purposes.

### BACKGROUND OF THE INVENTION

1. Field of the Invention

Embodiments of the present invention relate to micro electromechanical switch devices. More particularly, embodiments of the present invention relate to micro electromechanical layer switches and improvements thereof.

2. Description of the Background Art

Historically, microscopic mechanical elements fabricated on silicon chips by techniques similar to those used to manufacture integrated circuits (IC) have been referred to as micro-electromechanical devices or MEMs. Forming a functional MEMS structure on a substrate is a complicated task that requires the deposition, patterning and etching of various layers of thin films having a thickness anywhere between a few nanometer to about 100 micrometer. Unfortunately, the traditional precision engineering, chemical or mechanical processes necessary for manufacturing an IC are ill suited to the manufacture of low cost MEMs.

While not all MEMs rely on silicon or IC manufacturing techniques, it has been difficult to produce reliable and inexpensive MEMs using techniques that rely on low cost printing techniques on plastic or other low cost layers. One such printed MEMs technology under development by Rolltronics Corporation, the assignee of the present invention, provides a MEMs that has a substantially non-pliable layer and a flexible layer both of which include electrodes that when energized create electrostatic forces that attracts the flexible layer to the non-pliable layer. These MEMs devices can be roll printed on plastic substrates and provide a substantial reduction in both material and manufacturing cost compared to silicon-based MEMs. However, it was discovered diaphragm-like deflection introduced by electrostatic attraction caused the flexible layer to stretch too much thereby limiting the use of acceptable material to flexible films that were too thin or that required the distance between the non-pliable layer and the flexible layer to be too small. The other alternative use was to limit layer material to films with a low elastic modulus. Accordingly, what is needed is an improvement that enables thicker material to be used for the flexible layer, allows use of material with a wider range of elasticity modulus for the flexible layer and enables the flexible layer to be spaced further apart from the non-pliable layer. It is further desired to improve the response of the printed MEMs to an activation voltage and to otherwise reduce the sensitivity of the printed MEMs to variation in material selected for use as the flexible layer.

### SUMMARY OF EMBODIMENTS OF THE INVENTION

The present invention provides improved printed micro electromechanical devices (MEMs). By incorporating a plurality of perforations or apertures into the flexible layer of a MEMs device, it is possible to beneficially alter operational properties such as electrostatic sensitivity, resonance frequency, rate of change of sensitivity above the resonance frequency, oscillating mass, panel stiffness and others. The apertures enable the use of thicker material for the flexible layer, allows use of material having with a wider range of elasticity modulus for the flexible layer and enables the flexible layer to be spaced further apart from the non-pliable layer. The present invention further improves the response of the printed MEMs to an activation voltage and to otherwise reduce the sensitivity of the printed MEMs to variation in material selected for use as the flexible layer.

Embodiments of the present invention provide MEMs that are manufactured using low cost printing techniques on plastic substrates or other flexible materials. The MEMs include a support layer and a substantially flexible layer both of which include electrodes that, when energized, create electrostatic forces to attract the flexible layer to the non-pliable layer. The electrodes comprise conductive inks that are printed on the respective substrates.

In one embodiment, the MEMs comprises a plastic layer on which is printed a plurality of electrodes. A spacer layer is printed onto the layer to form cells juxtaposed over the electrode where each cell defines either a pixel in a display, a switch or some other type of electrical device. The spacer layer also couples a flexible layer to the plastic layer such that the flexible layer is nominally maintained in a spaced-apart relationship relative to the plastic layer. Each cell on the flexible layer includes a corresponding electrode that is printed on the flexible layer. When appropriate voltages are applied to the electrodes an electrostatic attraction force is generated causing the flexible layer will deflect or bend and make mechanical contact with the plastic layer.

n accordance with the present invention, the flexural stiffness of the flexible layer is reduced by the incorporation of a plurality of holes or other apertures that allows the cell to expel gas from between the layer whenever appropriate voltages are applied. In one embodiment, a geometrically uniform arrangement of holes in the flexible layer reduces the apparent stiffness and allows the use of thicker material without reducing the active area of the electrode that generates the electrostatic attraction force.

The present invention further recognizes that the flexible layer can be made to deflect in a complex fashion, rather than to simply deflect as a diaphragm. Accordingly, in further embodiments, the deflecting layer includes a plurality of geometrically arranged slots that imparts a rotational motion to the flexible layer when the MEMs is activated.

In yet another embodiment, the non-pliable layer includes at least one hole to provide additional venting for air or other gas in the cell during operation.

The foregoing and additional features and advantages of this invention will become apparent from the detailed description and review of the associated drawing figures that follow.

### BRIEF DESCRIPTION OF THE DRAWINGS

FIG. 1 is a sectional side view of an exemplary cell of an exemplary micro-electromechanical device in an OFF state in accordance with an embodiment of the present invention.

FIG. 2 is a sectional side view of an exemplary cell of an exemplary micro-electromechanical device in an ON state in accordance with an embodiment of the present invention.

FIG. 3 is a top view of a flexible layer in a cell of an exemplary micro-electromechanical device in accordance with an embodiment of the present invention.

FIG. 4 is a top view of a flexible layer in a cell of another exemplary micro-electromechanical device in accordance with an embodiment of the present invention.

FIG. 5 is a top view of a non-pliable layer in a cell of another exemplary micro-electromechanical device in accordance with an embodiment of the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

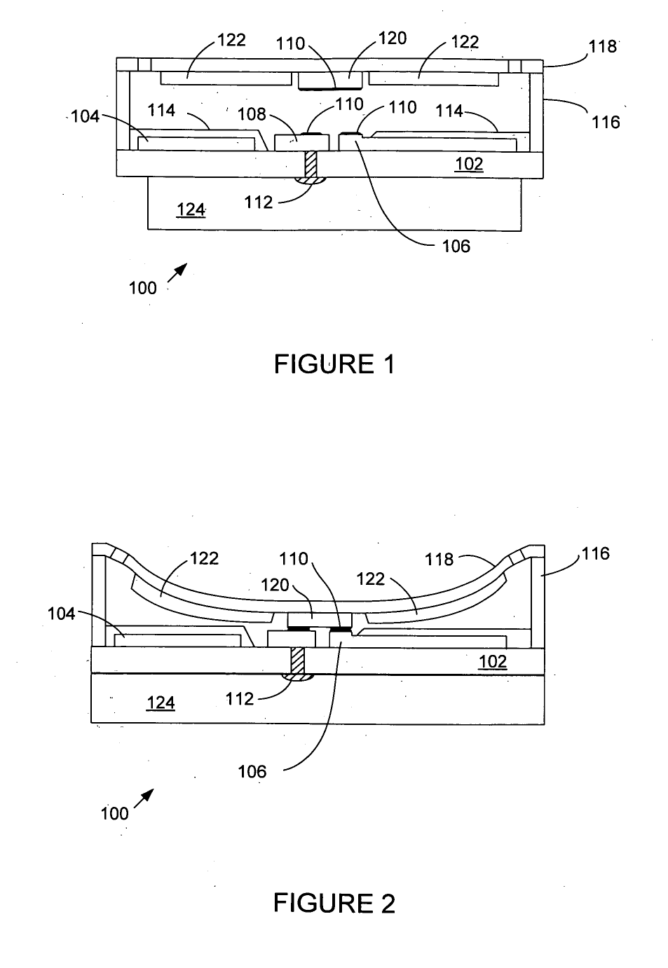

Referring now to the drawings more particularly by reference numbers, an exemplary sectional side view of a cell 100 of a micro-electromechanical device in accordance with an embodiment of the present invention is shown in FIGS. 1 and 2. In many applications, millions of such cells will be arrayed in a matrix or other pattern. By creating an electrostatic force, opposing foils in each cell are selectively controlled to indicate an ON or OFF state. Cell 100 may be adapted to stores digital information with minimal power requirements, functions as a micro-electromechanical switch or as a sensor. Features of cell 100 is disclosed in the related co-pending application entitled “MICRO-ELECTROMECHANICAL SWITCHING BACKPLANE” by Michael Sauvante, et al, application Ser. No. 10/959,604 (the '604 application), filed Oct. 5, 2004 the entire disclosure of which is herein incorporated by reference.

As disclosed in the '604 application, cell 100 is constructed with at least two layers. A substantially non-pliable layer 102 is used as a reference plane for the cell. An electrode, such as a column electrode 104, is printed or otherwise formed on non-pliable layer 102. Preferably, electrode 104 comprises a pattern of copper that is printed or otherwise deposited and patterned on non-pliable layer 102. Proximate to electrode 104 are a first contact pad 106 and a second contact pad 108 both of which are electrically isolated from electrode 104 and each other. Contact pad 106 is coupled to a power source. Contact 108, which is closely proximate to but electrically isolated from contact 106, is connected to a power source but is coupled by a via 112 to an output element 124. Output element 124 may be a metal contact pad, an electrophoretic material or other electrical element. Both contacts 106 and 108 have a coating of chromium 110 applied along the contact's surface to minimize stiction and oxidation of the contact. To prevent electrical shorts, a thin insulator 114 is applied over electrode 104 and portions of the contact 106. Insulator 114 may be an oxide, an epoxy or a non-conducting ink.

A substantially flexible layer 118 is maintained in a parallel spaced apart relationship with respect to non-pliable layer 102 by a spacer layer 116. Layer 118 has bridge contact 120 and a second electrode 122 either printed or deposited on layer 118. Preferably, electrode 122 is a pattern of a metal such as aluminum. It is preferred that the metal have a modulus of elasticity that is similar to the modulus of elasticity of the flexible layer. Bridge contact 120 is proximate to electrode 122 and is patterned on layer 118 but electrically separate from electrode 122. Bridge contact 120 is positioned closely proximate to the center of cell 100 and in alignment with contacts 106 and 108 such that it bridges contacts 106 and 108 to form a circuit when the flexible layer is mechanically switched, or brought into proximity with the non-pliable layer. Bridge contact 120 also preferably has a layer of chromium applied to its contact surface.

Spacer layer 116 is essentially a frame that extends around cell 100 to support flexible layer 118 in a spaced apart relationship with respect to non-pliable layer 102. Conceptually, spacer layer 116 forms a perimeter and defines the boundary of cell 100. Spacer layer 116 creates a region in the interior region of cell 100 into which flexible layer will intrude when the proper electrical controls are applied to electrodes 104 and 122.

Spacer layer 116 may be a patterned plastic foil that is ultrasonically or chemically bonded or heat welded to layers 102 and 118. However, it is preferred that spacer layer 116 be defined by a printing process that accurately places ink or similar material to define the perimeter of cell 100. Alternatively, spacer layer 116 can be defined by coating non-pliable layer (or flexible layer) with a photoresist material that is coated on or applied to the layer, dried or cured and patterned using well-known photolithography techniques. The thickness of spacer layer 116 is preferably in the range of 0.5 μm to about 50 μm, but can be usefully implemented outside this range as the display size and resolution mandates. It is desirable that spacer layer 116 be as high or tall as possible to compensate for surface variations in the layers. In most applications, spacer layer will range from about 41 μm to about 25 μm. In general, any suitable fabrication techniques can be employed to create the structures described herein.

Spacer layer 116 is sufficiently elastic to allow some torquing but is sufficiently stiff to support layer 118. It is to be noted that as used herein, the terms “non-pliable” and “flexible” are used to denote a degree of either rigidity or flexibility so long as the layers are rigid enough to give the cell the necessary structural integrity and operation.

Typically, selecting a slightly thicker layer for layer 102 or a higher elastic modulus than the elastic modulus for layer 118 achieves sufficient structural stiffness. It should be apparent that different materials and material properties (dimensions, elastic modulus, etc.) may be used and still achieve the desired functionality.

Layers 102 and 118 are both preferably selected from material that is both flexible and have a long flexural lifetime. Preferred materials that can meet these requirements include polymers and more specifically, polyimides, polyethylene terephthalate (PET), polyethylene naphthalate (PEN) and many other polymer alloys or elastic material. Although, in one embodiment, non-pliable layer is substantially rigid, it will be appreciated that absolute rigidity is not necessary to a successful implementation. Thus, the non-pliable layer may be glass or ceramic if high rigidity is desired and weight or cost is not a concern. Alternatively, layer 102 may be a relatively thick and less flexible layer of the preferred material if weight and costs are to be minimized for the specific application. Depending on the type of material selected for layer 102 and layer 118, the flexibility will be inversely proportional to the thickness of the layer. Thus, the thickness of non-pliable layer is to be determined by the requirements of a particular application or the type of material selected for the layer. Useful range of thickness of non-pliable layer extends from about 10 μm to about 100 μm; however, thicknesses outside this range are contemplated.

Flexible layer may be selected from the same preferred material as non-pliable layer or may be of a different material. However, since flexible layer is intended to extend from an initial spaced-apart position disposed parallel to the non-pliable layer to a position where the two layers are in mechanical contact with each other, it is preferred that layer 118 have at least two apertures 126 located near the edge of each cell. Apertures 126 allow gas in cavity 128 to flow out when switching to the ON state or to flow back into the cell when switching to the OFF state. Thus, although the selected thickness and pliability of layer 118 will vary as a function of the material selected and the intended application, apertures 126 enable the selection of material having a higher elastic modulus or the use of thicker layers for the flexible layers.

When flexible layer 118 is switched to the ON state such as is illustrated in FIG. 2, it is subjected to a diaphragm-like deflection introduced by electrostatic attraction towards layer 102. However, without apertures 126, a substantial amount of material stretching is required in order to engage bridge contact 120 with contacts 106 and 108. To ensure that the electrostatic attraction was sufficient, a higher voltage level was required to actuate the switch. Further, the ability to stretch imposed a design requirement for flexible layer that required either the use of a film that was very thin or a reduced height of the spacing layers 116. Further still, the flexible layer required the use of a film with a low elastic modulus. Apertures 126 can be incorporated to make flexible layer 118 to deflect in a complex fashion, rather than to simply deflect as a diaphragm. This deflecting structure, created by the correct incorporation of slotted holes in flexible layer 118.

Because each layer carries opposing contacts coupled to drive electronics, a circuit is completed whenever flexible layer 118 is moved sufficiently close to non-pliable layer 104. When layer 118 deflects toward layer 102, bridge contact 120 electrically couples contact 106 to contact 108 and forms a circuit to provide power to contact 112 and the MEMs is in an ON state. When the flexible layer is allowed to return to its spaced apart relationship with respect to layer 102, the circuit is broken and MEMs is in an OFF state. Without the attractive electrostatic force between the electrodes, the mechanical force caused by the deflection of flexible layer causes it to spring away and physically separate from the non-pliable layer.

The mechanism for switching cell 100 comes about by creating an electrostatic force to attract flexible layer 118 to non-pliable layer 102. With electrostatic forces present, that is, when electrodes 104 and 122 are biased with a voltage differential that is sufficient to create the electrostatic force, flexible layer will be deflected or pulled toward the non-pliable layer until the two layers are in a mechanically engaged relationship.

FIG. 2 schematically illustrates the deflection of flexible layer 118 that occurs when the proper voltages are applied to electrodes 104 and 122. As illustrated, flexible layer is mechanically deflected until bridge contact 120 engages contact pads 106 and 108. When the electrode voltage is removed, the mechanical energy stored in flexible layer 118 causes the electrodes to separate when contact 114 breaks contact with contact pad 106. To minimize the flexural stiffness of flexible layer 118, apertures 126 reduce the apparent stiffness of layer 118 by reducing mass of the layer, adjusting cell pressure during operation and by creating continuity gaps along the edge of flexible layer proximate to the cell boundary. The beneficial reduction in mass of flexible layer reduces the response time due to the decreased mass of the oscillating flexible layer. The apertures also alter electrostatic sensitivity or threshold of the switch cell by reducing the pressurization of the cell as the flexible layer is drawn toward the non-pliable layer. Sufficient contact between flexible layer 118 and spacer layer 116 must be maintained to provide a secure bond between the two layers and to ensure that sufficient mechanical force is developed in the flexible layer 118 to return the flexible layer to an OFF state. Accordingly, it is preferred that the cumulative length of slots 130 and 132 do not exceed more than 90% of the length of the adjacent side of cell 100.

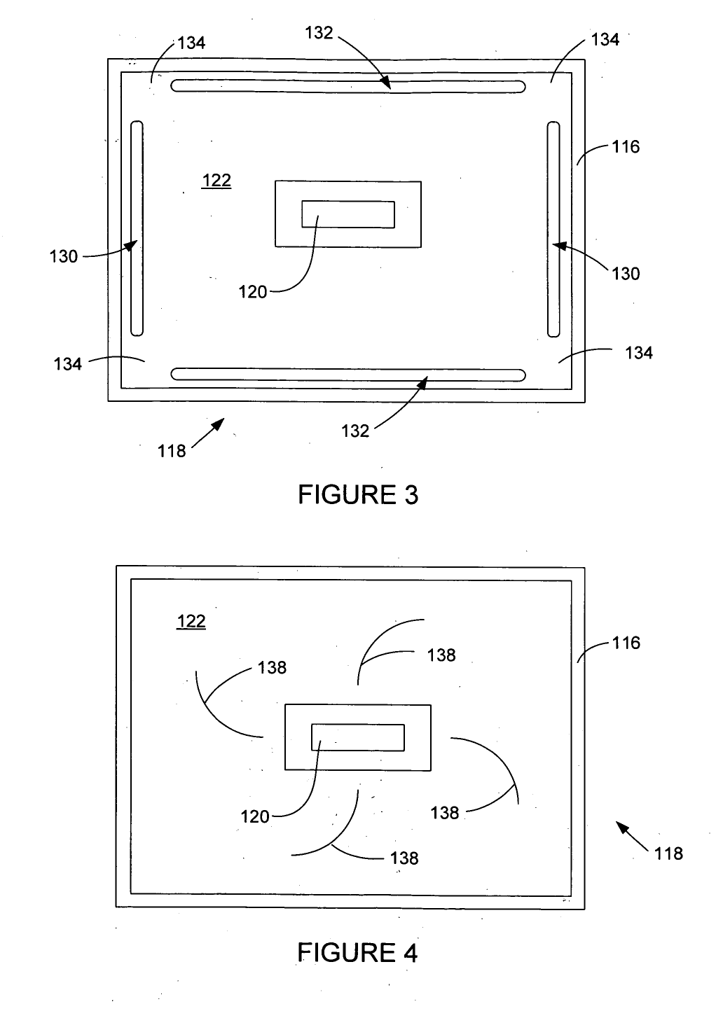

A bottom view of the flexible layer is shown in FIG. 3 illustrating one embodiment that reduces the flexural stiffness of flexible layer 118 without substantially reducing the area for electrostatic attraction. In this embodiment, flexible layer 118 includes a plurality of slots 130 and 132 along the cell boundary, which is defined by layer 116. The slot structures in flexible layer 118 require that electrical connections be routed around the slots. In one embodiment, connections are routed out of the cell in at least one of the corner regions such indicated at 134.

This structural change alters the elastic behavior of the active area of flexible layer 118. More specifically, the elastic behavior of flexible layer 118 is dominated by the elastic behavior of a cell element that is the size of the long axis of the cell. Upon deflection, layer C will deflect both length wise into the long axis of the cell and with a bow across the perpendicular minor axis. The cross axis bowing will have a beneficial effect on the forces pulling active contact 120 into place. It is important to realize that the nature of the deflection remains that of a deflecting diaphragm.

It is noted that a higher aspect ratio for cell is preferred because a cell that has a length dimension that is larger than the width dimension has a significant beneficial effect on the elastic behavior of the flexible layer 118. Further, it is also preferred that the aspect ratio between height and width be as high as practical for a give application. When incorporated into designs that have the slot holes, a high aspect ratio cell can significantly broaden the types and thicknesses of flexible materials that can be selected for flexible layer 118 and compensate for any variation in material.

FIG. 4 shows another embodiment of the present invention where the apertures comprise a pattern of symmetrical spiraling slots 138 in flexible layer 118. This pattern is less sensitive to the aspect ratio of the cell. As this structure is deflected downward toward the non-pliable layer 102, the contact point will rotate. As the metal contacts 106 and 108 engage bridging contact 120 metal surfaces may become scuffed due to the twisting of the flexible layer 118. This scuffing action contributes to low resistance and long-lived switch contacts and is a significant benefit to the device design.

The embodiment shown in FIG. 4 is affected by the out of plane forces. The addition of out of plane bending and twisting in the flexible layer 118 has a significant effect on the apparent elasticity of the layer. More specifically, it is possible to beneficially alter operational properties such as electrostatic sensitivity, resonance frequency, rate of change of sensitivity above the resonance frequency, oscillating mass, panel stiffness and others. The perforations enable the use of thicker material for the flexible layer, allows use of material having with a wider range of elasticity modulus for the flexible layer and enables the flexible layer to be spaced further apart from the non-pliable layer. The present invention further improves the response of the printed MEMs to an activation voltage and to otherwise reduce the sensitivity of the printed MEMs to variation in material selected for use as the flexible layer.

Reduction in electrostatic attraction forces by the incorporation of slots in flexible layer 118 is compensated for by a reduction in the elasticity of the film. A reduction in the apparent elasticity of flexible layer 118 due to the incorporation of slots of various shapes is extremely important in the manufacturing process. The alternative methods of manufacture using roll-to-roll technology depend on either the selection of a polymer foil with an extremely low elastic modulus or the incorporation of slots in the flexible layer. With the low elastic modulus foil, material handling and metal deposition processes are complicated by choice of low modulus material. However, if a relatively high modulus material is used for the flexible layer, electrical connections are relatively easier. The apertures or slots are carved into flexible layer 118 by means well known in the art including laser patterning. For example, while the foil is on a roll, either an infrared laser or a short pulse UV laser can cut the apertures. The use of UV lasers is preferred because there is less material damage during the cutting process. Other well known etching processes such as wet etching or dry etching, would be acceptable to form the apertures. The resolution of the aperture is within the level of skill in the art using any of these technologies.

By adjusting the size and shape of the apertures in the structure of cell 100, it is possible to alter the frequency and susceptibility to breakup of the flexible level. When flexible layer 118 is switching at frequencies approaching the resonance frequency of the cell, a phenomenon called “breakup” may occur where it is no longer correct to view the flexible element as a single structure resonating at a single frequency. Rather, at such operating frequencies, it is necessary to view flexible layer 118 as a surface that is supporting several frequency modes, which is a well-known phenomenon in loudspeaker design where the flexible surface will be resonating at several frequencies at once. These frequencies include both the primary frequency and acoustic multiples of the primary frequency and can be damped by the addition of the apertures the deflecting layer is not treated as diaphragm deflections.

In another embodiment, incorporation of round holes spaced around the periphery of cell 100 has an almost linear response of reducing the flexural modulus and reducing the electrostatic attraction between flexible layer 118 and layer 102. However, the small improvement in the relationship of flexibility and electrostatic attraction is off-set by the fringing capacitance at the edges of the holes. As such, longer slot-like or elliptically-shaped holes are preferred in the flexible layer.

If apertures in either flexible layer 118 or non-pliable layer 102 are made before metallization, metal will coat the sidewalls of the perforation. The coating of the side walls with a seed layer of metal can be the basis for subsequent electroplating of a thicker metal coating into perforations and the possibility of the creation of conducting through holes onto the back side of each layer. Electrically conductive through holes alter and enhance the applicability of cell 100 for use with a variety of display materials and technologies, including but not limited to LCD, OLED, electrochromic and electrophoretic displays.

The critical component in manufacturing a cell is in careful selection of the flexible layer material, its physical properties and the elastic modulus. PET and polyimide are preferred material for flexible layer 118. In general, materials with an elastic modulus exceeding 1×10⁸ kg/m² become useful. The teachings of this invention allow for an increase in spacing between layers and a degree of flexibility in the use of high elastic modulus materials. Aluminum is the preferred metal for electrode 122 although other conductive material such as ITO or copper may be used in place of aluminum. In general, commonly acceptable conductive materials used in flexible circuit manufacturing may be suited for use in cell 100. With a very thin metal layer its mechanical properties do not dominate. Flexible layer 118 is attached to the spacer layer 116 by ultrasonic welding, adhesive bonding or similar known technique.

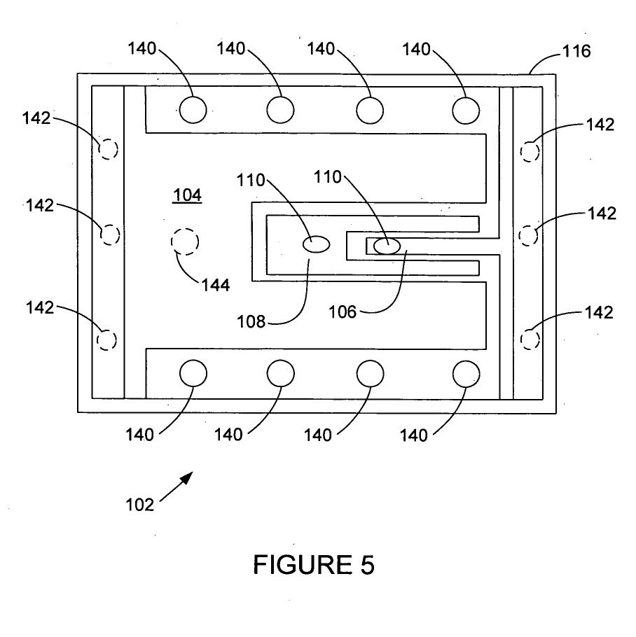

Referring now to FIG. 5 where a plan view of non-pliable layer 106 is shown having a plurality of holes 140, 142 and 144. Holes 140 are positioned proximate to spacer layer 116 along each side of the cell 100. Holes 140 are typically used relieve pressure within the cell when switching to the ON state and to overcome any vacuum suction or stiction within the cell when switching to the OFF state. Additional holes 142 are shown in dashed line to illustrate the possibility of positioning holes along all four sides of cell 100. Similarly, hole 144 is shown in dashed line to illustrate the possibility of positioning a hole in the area of the cell typically covered by electrode 104. Because non-pliable layer 102 does not necessarily flex to the same degree as flexible layer 118, holes may be round, elliptical or slot shaped, the primary purpose being to enable gas to escape or enter the cell during operation. It is preferred that holes be positioned around the periphery of cell 100 so that the area of electrode 104 is not reduced and to minimize interference with any display media coupled to cell 100. Further, a plurality of small holes may be used in some applications while fewer larger holes may be used in other applications, the selection being dictated by engineering constraints for a particular application. When holes are used in non-pliable layer 102, it is preferred that a suitable barrier be applied on the opposite side of output element 124 to minimize entry of contaminants. Such a barrier (not shown) may be a foil, glass or similar plate that is offset from output element 124 such that the barrier defines a reservoir for the air escaping from cell 100. Holes 140, 142 and 144 may be formed in the manner described above. It is noted that it may be necessary to reduce the area of electrode 104 to provide space for the holes however, it is preferred that the holes be cut or formed after the electrode is printed.

The MEMs described herein is suitable for many applications such as display, memory, and cross-point switching applications. It's ability to latch electronic information as a part of the switching structure, and to effect significant changes (amplification or impedance change) is novel and important. The MEMs, in accordance with the present invention, are well suited for roll to roll manufacture using inexpensive printing equipment and printing techniques.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, further embodiments may include various display architectures, biometric sensors, pressure sensors, temperature sensors, light sensors, chemical sensors, X-ray and other electromagnetic sensors, amplifiers, gate arrays, other logic circuits, printers and memory circuits.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A micro electromechanical device comprising:
a first layer and second layer maintained in a spaced apart relationship by a intermediate layer, said intermediate layer defining a cell boundary;
within said cell, an electrode printed on one side of said first layer and a corresponding electrode printed on an opposing side of said second layer such than when a bias exists, said first layer is deflected toward said second layer;
a plurality of contacts one of which is patterned on said first layer in proximity to said electrode and at least two of which are patterned on said second layer in proximity to said corresponding electrode, said plurality of contacts completing an electrical circuit when said first layer is deflected toward said second layer; and
a plurality of apertures in said first layer.

2. The micro electromechanical device of claim 1 wherein said plurality of apertures are cut into said first layer proximate to said intermediate layer.

3. The micro electromechanical device of claim 2 wherein said plurality of apertures comprise four slots.

4. The micro electromechanical device of claim 2 wherein said apertures comprise slots proximate to the boundary of said cell.

5. The micro electromechanical device of claim 4 wherein each of said slots are parallel to said intermediate layer.

6. The micro electromechanical device of claim 2 wherein the length of said slots is less than about 90% of the length of each edge of the cell.

7. The micro electromechanical device of claim 2 wherein said apertures comprise more than four slots.

8. The micro electromechanical device of claim 2 wherein said apertures comprise at least four spiraling slots.

9. The micro electromechanical device of claim 2 wherein said apertures comprise at least four slots symmetrically positioned around the contact on said first layer.

10. The micro electromechanical device of claim 2 wherein said apertures comprise at least four spiraling slots.

11. The micro electromechanical device of claim 1 wherein said apertures are cut into said first layer with a laser.

12. The micro electromechanical device of claim 1 wherein said apertures are cut into said first layer with a UV laser.

13. The micro electromechanical device of claim 1 wherein said first layer is selected from a foil of PET or polymide.

14. The micro electromechanical device of claim 1 wherein said first layer is a flexible layer and said second layer is a non-pliable layer.

15. A plurality of micro electromechanical cells arranged in a matrix, each of said cells comprising:
a flexible layer and non-pliable layer maintained in a spaced apart relationship by a spacer layer that define cell boundaries;
within each cell defined by said spacer layer, an electrode printed on one side of said flexible layer and a corresponding electrode printed on an opposing side of said non-pliable layer, such than when a bias exists, said flexible layer is deflected toward said non-pliable layer; and
means for reducing the flexural stiffness of the flexible layer.

16. The micro electromechanical device of claim 15 wherein said reducing means further comprises means for expelling gas from between the flexible layer and the plastic layer whenever appropriate voltages are applied to said electrodes.

17. The micro electromechanical device of claim 15 wherein said reducing means further comprises a plurality of apertures cut into said flexible layer.

18. The micro electromechanical device of claim 17 wherein said plurality of apertures comprise four slots.

19. The micro electromechanical device of claim 15 wherein said reducing means further comprises a plurality of holes cut into said non-pliable layer.

20. A micro electromechanical device having at least one cell defined by a plastic layer and a flexible layer maintained in a spaced apart relationship by a spacer layer, said plastic and flexible layers having opposing electrodes that are controllable to cause said flexible layer to deflect toward said plastic layer, said flexible layer having a plurality of slots to reduce the flexural stiffness of the flexible layer.

21. The micro electromechanical device of claim 20 wherein said slots are proximate to a boundary of said cell.

22. The micro electromechanical device of claim 20 wherein said slots include a plurality of slots symmetrically positioned around the center of said flexible layer.

23. The micro electromechanical device of claim 20 wherein said non-pliable layer includes a plurality of holes.
